(19) United States
(12) Patent Application Publication
(10) Pub. No.: US 2026/0307419 A1
(43) Pub. Date: Oct. 8, 2026

(54) POP-UP THREE-DIMENSIONAL (3D) GREETING CARD STRUCTURE WITH MOVABLE SUPPORT ARMS

(71) Applicant: Shanghai Vanpine Cosmetics Co., Ltd, Shanghai (CN)

(72) Inventor: Yuanyuan ZHAN, Shanghai (CN)

(73) Assignee: Shanghai Vanpine Cosmetics Co., Ltd, Shanghai (CN)

(21) Appl. No.: 19/432,962

(22) Filed: Dec. 25, 2025

(30) Foreign Application Priority Data
Apr. 7, 2025 (CN) 202510428045.7

(51) Int. Cl. B42D 15/04

(52) U.S. Cl. CPC B42D 15/045

(57) ABSTRACT

A pop-up three-dimensional (3D) greeting card structure with movable support arms includes: a middle panel, a middle-rear panel, movable support arms, and an outer casing. Cross-sections of the middle panel and the middle-rear panel are V-shaped; notches are respectively formed on two sides of the middle panel and two sides of the middle-rear panel; the notches on the middle panel are correspondingly interlocked with the notches on the middle-rear panel to form a rhombic grid; the movable support arms respectively extend from two ends of the middle-rear panel; middle panel adhesive flaps are respectively provided on two ends of the middle panel; middle-rear panel adhesive flaps are respectively provided on the two ends of the middle-rear panel; the outer casing is sleeved on the middle panel, the middle-rear panel and the movable support arms; and all the adhesive flaps are bonded to an inner wall of the outer casing.

### CROSS REFERENCE TO THE RELATED APPLICATIONS

This application is based upon and claims priority to Chinese Patent Application No. 202510428045.7, filed on Apr. 7, 2025, the entire contents of which are incorporated herein by reference.

### TECHNICAL FIELD

The present disclosure relates to the technical field of three-dimensional (3D) greeting cards, and in particular to a pop-up 3D greeting card structure with movable support arms.

### BACKGROUND

Pop-up 3D greeting cards in existing markets are structurally simple. They have an X-shaped internal structure. In use, by pushing up the bottom paper sheet, the pop-up part pops up, and the base stands on a table for display.

The prior art has the following drawbacks:

After the structure is deployed, all internal supports are X-shaped, which limits the display angle of the product. In addition to limitations in design, the structure has numerous assembly components, high requirements for accuracy of adhesive flaps, and low fault tolerance. Any misalignment may lead to functional failure. The structure is relatively sensitive to the height of the product. Exceeding a certain height will make the standing center of gravity unstable.

The statements herein merely provide general background information and do not necessarily constitute the prior art.

### SUMMARY

An objective of the present disclosure is to provide a pop-up 3D greeting card structure with movable support arms. The pop-up 3D greeting card structure solves the problem of the fixed structural shape, and enables diverse designs and styles, as well as extremely wide application scenarios.

The present disclosure provides a pop-up 3D greeting card structure with movable support arms, including: a middle panel, a middle-rear panel, movable support arms, and an outer casing, where both a cross-section of the middle panel and a cross-section of the middle-rear panel are V-shaped; notches are respectively formed on two sides of the middle panel and two sides of the middle-rear panel; the notches on the middle panel are correspondingly interlocked with the notches on the middle-rear panel to form a rhombic grid; the movable support arms respectively extend from two ends of the middle-rear panel; middle panel adhesive flaps are respectively provided on two ends of the middle panel; middle-rear panel adhesive flaps are respectively provided on the two ends of the middle-rear panel; the outer casing is sleeved on the middle panel, the middle-rear panel and the movable support arms; and the middle panel adhesive flaps and the middle-rear panel adhesive flaps are bonded to an inner wall of the outer casing.

According to the above technical solution, the middle panel and the middle-rear panel in the structure form the rhombic grid through their notches. Two movable support arms skillfully extend from the middle-rear panel. In use, pushing the movable support arms open along an arrow direction can deploy the greeting card to form a 3D effect for use and display. By reversely collapsing the movable support arms, this structure can be flattened and can be used repeatedly as needed. Meanwhile, more auxiliary panels similar to the front panel and the rear panel may further be provided in reserved internal space according to design requirements to form a more obvious 3D effect. This structure enables diverse designs and styles, as well as extremely wide application scenarios. In use, the movable support arms extending from the middle-rear panel come into contact with the middle panel to form stable triangles, thereby solving the problem of the fixed shape.

Further, the pop-up 3D greeting card structure further includes a front panel and a rear panel; both a cross-section of the front panel and a cross-section of the rear panel are V-shaped; front panel adhesive flaps are respectively provided on two ends of the front panel; rear panel adhesive flaps are respectively provided on two ends of the rear panel; the front panel adhesive flaps are connected to an inner wall of a front end of the outer casing, and the rear panel adhesive flaps are connected to an inner wall of a rear end of the outer casing.

Further, a centerline of the front panel, a centerline of the middle panel, a centerline of the middle-rear panel and a centerline of the rear panel are coplanar with a centerline of the outer casing.

According to the above technical solution, since the centerline of the front panel, the centerline of the middle panel, the centerline of the middle-rear panel, and the centerline of the rear panel in the structure are coplanar with the centerline of the outer casing, all components with centerlines coincident are bonded to specified positions of the outer casing through the front panel adhesive flaps, the middle panel adhesive flaps, the middle-rear panel adhesive flaps, and the rear panel adhesive flaps. At last, the outer casing can be bonded to itself. The structure can be flattened to a fully flat state for transportation or storage.

Further, a cross-section of the outer casing is circular.

Further, a cross-section of the outer casing is a regular 2n-sided polygon, where n is a natural number, and n≥2.

The pop-up 3D greeting card structure with movable support arms provided by the present disclosure forms a stable structure with a plurality of V-shaped components and innovatively takes the two movable support arms as supports. According to instructions, pushing the movable support arms open from the bottom can display the 3D effect. By reversely collapsing the movable support arms, this structure can be automatically restored and can be flattened for storage. The structure of the present disclosure is designed more flexibly in terms of external shapes, patterns, styles and the like. The middle panel and the middle-rear panel in the structure form the rhombic grid through their notches, such that a position of each component can be adjusted according to the 3D effect of the product to achieve a more vivid display effect. Moreover, more single V-shaped components can be added according to design requirements to form a more compact relationship and a 3D visual effect. With the movable support arms on two sides of the bottom, and the V-shaped components, the structure is pushed, pulled and used easily, without increasing the material cost. This skillfully solves the fixation problem after the product is formed, while not increasing the product cost. The product is bonded, assembled and aligned based on the centerlines during production, and is operated conveniently. The product can be deployed to form the 3D effect and can also be flattened to a fully flat state for transportation and storage.

### BRIEF DESCRIPTION OF THE DRAWINGS

FIG. 1 is a schematic structural view of a pop-up 3D greeting card structure provided by an embodiment of the present disclosure;

FIG. 2 is a schematic structural view of the pop-up 3D greeting card structure in FIG. 1 from another viewing angle;

FIG. 3 is a schematic structural view of a first flattened state of the pop-up 3D greeting card structure in FIG. 1;

FIG. 4 is a schematic structural view of a second flattened state of the pop-up 3D greeting card structure in FIG. 1;

FIG. 5 is a schematic structural view of a third flattened state of the pop-up 3D greeting card structure in FIG. 1;

FIG. 6 is a schematic structural view of a rectangular outer casing of the pop-up 3D greeting card structure in FIG. 1;

FIG. 7 is a schematic structural view of a hexagonal outer casing of the pop-up 3D greeting card structure in FIG. 1;

FIG. 8 is a schematic structural view of an octagonal outer casing of the pop-up 3D greeting card structure in FIG. 1; and

FIG. 9 is a schematic structural view of a decagonal outer casing of the pop-up 3D greeting card structure in FIG. 1.

### REFERENCE NUMERALS

100: middle panel
110: middle panel adhesive flap
200: middle-rear panel
210: middle-rear panel adhesive flap
300: movable support arm
400: outer casing
500: notch
600: rhombic grid
700: front panel
710: front panel adhesive flap
800: rear panel
810: rear panel adhesive flap

### DETAILED DESCRIPTION OF THE EMBODIMENTS

The specific implementations of the present disclosure are described in more detail below with reference to the accompanying drawings and embodiments. The following embodiments are intended to illustrate the present disclosure, but not to limit the scope of the present disclosure.

It should be noted that the terms "first", "second", "third", "fourth", and the like in the description and claims of the present disclosure are intended to distinguish between similar objects but do not necessarily indicate a specific order or sequence.

### Embodiment 1

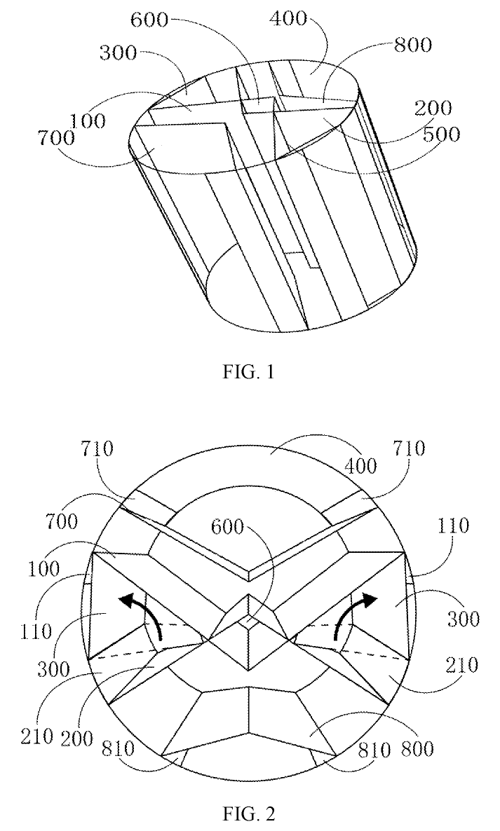

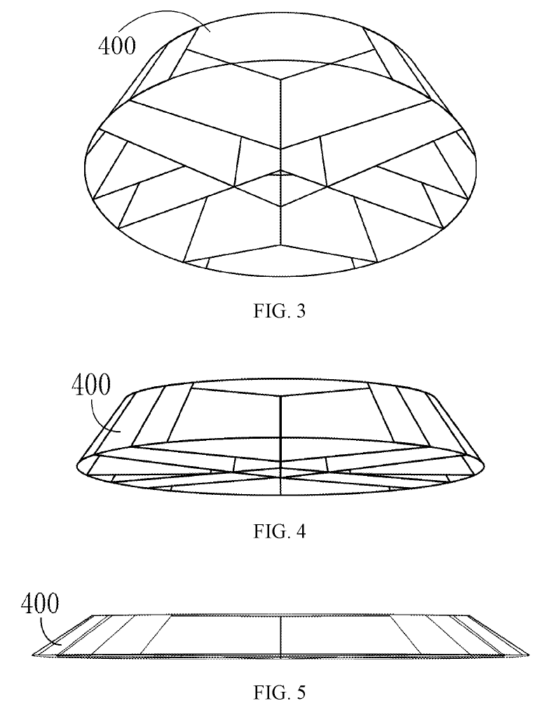

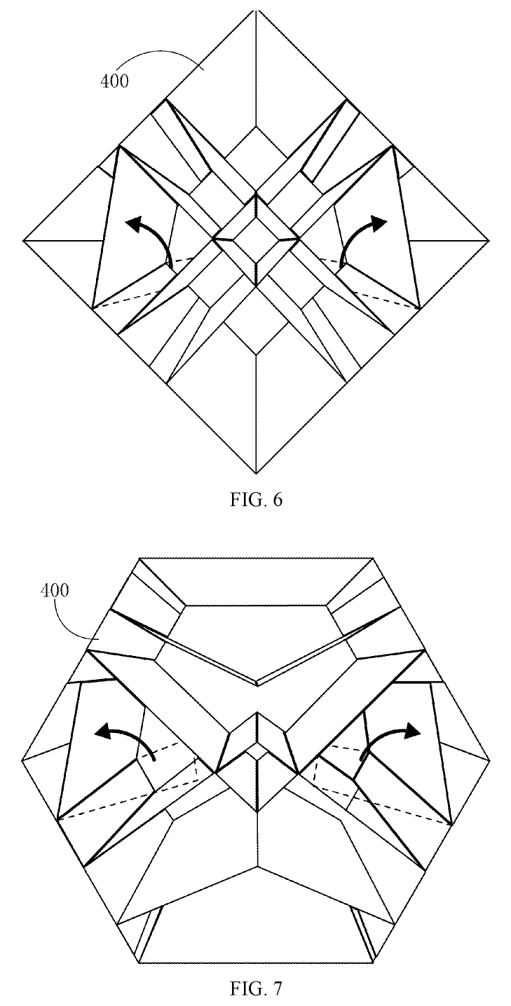

FIG. 1 is a schematic structural view of a pop-up 3D greeting card structure provided by an embodiment of the present disclosure. FIG. 2 is a schematic structural view of the pop-up 3D greeting card structure in FIG. 1 from another viewing angle. FIG. 3 is a schematic structural view of a first flattened state of the pop-up 3D greeting card structure in FIG. 1. FIG. 4 is a schematic structural view of a second flattened state of the pop-up 3D greeting card structure in FIG. 1. FIG. 5 is a schematic structural view of a third flattened state of the pop-up 3D greeting card structure in FIG. 1. Referring to FIG. 1, FIG. 2, FIG. 3, FIG. 4, and FIG. 5, an embodiment of the present disclosure provides a pop-up 3D greeting card structure with movable support arms, including middle panel 100, middle-rear panel 200, movable support arms 300, and outer casing 400. A cross-section of the outer casing 400 is circular. Both a cross-section of the middle panel 100 and a cross-section of the middle-rear panel 200 are V-shaped. Notches 500 are respectively formed on two sides of the middle panel 100 and two sides of the middle-rear panel 200. The notches 500 on the middle panel 100 are correspondingly interlocked with the notches 500 on the middle-rear panel 200 to form rhombic grid 600. The movable support arms 300 respectively extend from two ends of the middle-rear panel 200. Middle panel adhesive flaps 110 are respectively provided on two ends of the middle panel 100. Middle-rear panel adhesive flaps 210 are respectively provided on the two ends of the middle-rear panel 200. The outer casing 400 is sleeved on the middle panel 100, the middle-rear panel 200 and the movable support arms 300. The middle panel adhesive flaps 110 and the middle-rear panel adhesive flaps 210 are bonded to an inner wall of the outer casing 400.

It is to be noted that the middle panel 100 and the middle-rear panel 200 in the structure form the rhombic grid 600 through their notches 500. Two movable support arms 300 skillfully extend from the middle-rear panel 200. In use, pushing the movable support arms 300 open along an arrow direction can deploy the greeting card to form a 3D effect for use and display. By reversely collapsing the movable support arms 300, this structure can be flattened and can be used repeatedly as needed. Meanwhile, more auxiliary panels similar to the front panel and the rear panel may further be provided in reserved internal space according to design requirements to form a more obvious 3D effect. This structure enables diverse designs and styles, as well as extremely wide application scenarios. In use, the movable support arms 300 extending from the middle-rear panel 200 come into contact with the middle panel 100 to form stable triangles, thereby solving the problem of the fixed shape.

Further referring to FIG. 1 and FIG. 2, in the present disclosure, the pop-up 3D greeting card structure further includes front panel 700 and rear panel 800. Both a cross-section of the front panel 700 and a cross-section of the rear panel 800 are V-shaped. Front panel adhesive flaps 710 are respectively provided on two ends of the front panel 700. Rear panel adhesive flaps 810 are respectively provided on two ends of the rear panel 800. The front panel adhesive flaps 710 are connected to an inner wall of a front end of the outer casing 400. The rear panel adhesive flaps 810 are connected to an inner wall of a rear end of the outer casing 400.

Further, in the present disclosure, a centerline of the front panel 700, a centerline of the middle panel 100, a centerline of the middle-rear panel 200 and a centerline of the rear panel 800 are coplanar with a centerline of the outer casing 400.

It is to be noted that since the centerline of the front panel 700, the centerline of the middle panel 100, the centerline of the middle-rear panel 200, and the centerline of the rear panel 800 in the structure are coplanar with the centerline of the outer casing 400, all components with centerlines coincident are bonded to specified positions of the outer casing 400 through the front panel adhesive flaps 710, the middle panel adhesive flaps 110, the middle-rear panel adhesive flaps 210, and the rear panel adhesive flaps 810. At last, the outer casing 400 can be bonded to itself. The structure can be flattened to a fully flat state for transportation or storage.

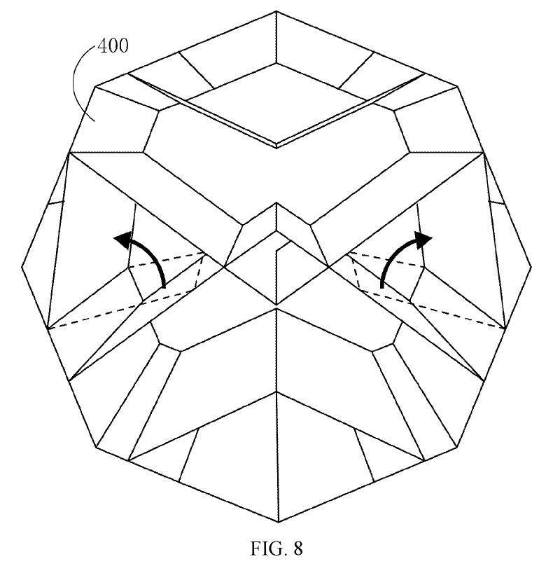

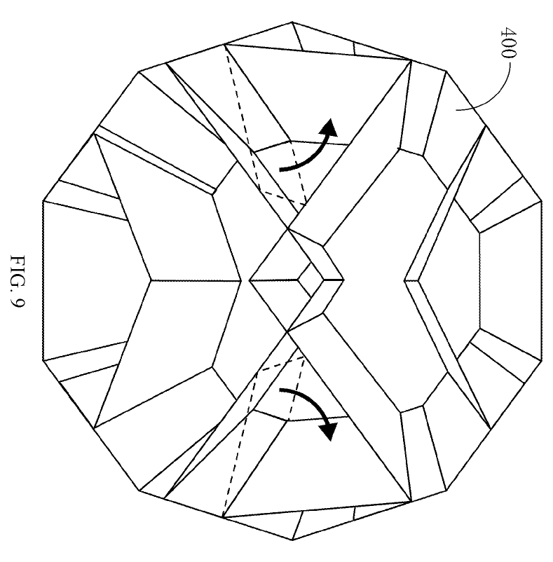

FIG. 6 is a schematic structural view of a rectangular outer casing of the pop-up 3D greeting card structure in FIG. 1. FIG. 7 is a schematic structural view of a hexagonal outer casing of the pop-up 3D greeting card structure in FIG. 1. FIG. 8 is a schematic structural view of an octagonal outer casing of the pop-up 3D greeting card structure in FIG. 1. FIG. 9 is a schematic structural view of a decagonal outer casing of the pop-up 3D greeting card structure in FIG. 1. Referring to FIG. 6, FIG. 7, FIG. 8, and FIG. 9, in the present disclosure, a cross-section of the outer casing 400 is a regular 2n-sided polygon, where n is a natural number, and n≥2. For example, it is a square or a regular hexagon or a regular octagon, or a regular decagon.

It is to be noted that the outer casing 400 may be an independent component, and may also be two or more components that are bonded to each other to form a single component.

Based on the above description, the present disclosure has the following advantages:
1. The pop-up 3D greeting card structure with movable support arms provided by the present disclosure forms a stable structure with a plurality of V-shaped components, and further innovatively takes the two movable support arms as supports. According to instructions, pushing the movable support arms open from the bottom can display the 3D effect. By reversely collapsing the movable support arms, this structure can be automatically restored, and can be flattened for storage.
2. The pop-up 3D greeting card structure with movable support arms provided by the present disclosure is designed more flexibly in terms of external shapes, patterns, styles and the like.
3. According to the pop-up 3D greeting card structure with movable support arms provided by the present disclosure, the middle panel and the middle-rear panel in the structure form the rhombic grid through their notches, such that a position of each component can be adjusted according to the 3D effect of the product to achieve a more vivid display effect. Moreover, more single V-shaped components can be added according to design requirements to form a more compact relationship and a 3D visual effect.
4. With the movable support arms on two sides of the bottom, and the V-shaped components, the pop-up 3D greeting card structure with movable support arms provided by the present disclosure is pushed, pulled and used easily, without increasing the material cost. This skillfully solves the fixation problem after the product is formed, while not increasing the product cost.
5. According to the pop-up 3D greeting card structure with movable support arms provided by the present disclosure, the product is bonded, assembled and aligned based on the centerlines during production, and is operated conveniently. The product can be deployed to form the 3D effect, and can also be flattened to a fully flat state for transportation and storage.

The above are merely specific implementations of the present disclosure, and the protection scope of the present disclosure is not limited thereto. Any modification or replacement easily conceived by those skilled in the art within the technical scope of the present disclosure should fall within the protection scope of the present disclosure. Therefore, the protection scope of the present disclosure shall be subject to the protection scope of the claims.

1. A pop-up three-dimensional (3D) greeting card structure with movable support arms, comprising: a middle panel, a middle-rear panel, movable support arms, and an outer casing, wherein
a cross-section of the middle panel and a cross-section of the middle-rear panel are V-shaped; notches are respectively formed on two sides of the middle panel and two sides of the middle-rear panel; the notches on the middle panel are correspondingly interlocked with the notches on the middle-rear panel to form a rhombic grid; and the movable support arms respectively extend from two ends of the middle-rear panel; and
middle panel adhesive flaps are respectively provided on two ends of the middle panel; middle-rear panel adhesive flaps are respectively provided on the two ends of the middle-rear panel; the outer casing is sleeved on the middle panel, the middle-rear panel and the movable support arms; and the middle panel adhesive flaps and the middle-rear panel adhesive flaps are bonded to an inner wall of the outer casing.

2. The pop-up 3D greeting card structure according to claim 1, further comprising a front panel and a rear panel, wherein a cross-section of the front panel and a cross-section of the rear panel are V-shaped; front panel adhesive flaps are respectively provided on two ends of the front panel; and rear panel adhesive flaps are respectively provided on two ends of the rear panel; and
the front panel adhesive flaps are connected to an inner wall of a front end of the outer casing, and the rear panel adhesive flaps are connected to an inner wall of a rear end of the outer casing.

3. The pop-up 3D greeting card structure according to claim 2, wherein a centerline of the front panel, a centerline of the middle panel, a centerline of the middle-rear panel and a centerline of the rear panel are coplanar with a centerline of the outer casing.

4. The pop-up 3D greeting card structure according to claim 1, wherein a cross-section of the outer casing is circular.

5. The pop-up 3D greeting card structure according to claim 1, wherein a cross-section of the outer casing is a regular 2n-sided polygon, wherein n is a natural number, and n≥2.
